(19) United States
(12) Patent Application Publication
(10) Pub. No.: US 2008/0136777 A1
(43) Pub. Date: Jun. 12, 2008

(54) SWEAT-FREE MOUSE DEVICE

(75) Inventors: Ming-Hsun Lu, Taipei (TW); Hong-Che Yen, Taipei (TW)

Correspondence Address: KIRTON AND MCCONKIE, 60 EAST SOUTH TEMPLE,, SUITE 1800, SALT LAKE CITY, UT, 84111, US

(73) Assignee: PRIMAX ELECTRONICS LTD., Taipei (TW)

(21) Appl. No.: 11/680,019

(22) Filed: Feb. 28, 2007

(30) Foreign Application Priority Data
Dec. 8, 2006 (TW) 095145919

(51) Int. Cl. G06F 3/033

(52) U.S. Cl. 345/163

(57) ABSTRACT

A sweat-free mouse device includes a mouse main body and a sweat-free cover. The mouse main body has an upper surface for resting a user's palm thereon and includes a recess structure in the upper surface thereof, wherein a first magnetic element is disposed in the recess structure. The sweat-free cover is used for covering the recess structure and includes a cover body and an adsorbent article. A first surface of the cover body is sheltered by the adsorbent article. A second magnetic element is disposed on a second surface of the cover body. The first magnetic element and the second magnetic element are magnetically coupled to each other such that the sweat-free cover is securely attached onto the upper surface of the mouse main body.

### FIELD OF THE INVENTION

The present invention relates to a mouse device, and more particularly to a sweat-free mouse device.

### BACKGROUND OF THE INVENTION

Nowadays, online games have experienced great growth and are now rapidly gaining in popularity. For complying with great progress of the online games, the hardware and peripheral devices of the computer are unceasingly innovated. In fact, the most important innovation in peripheral devices in recent years includes the development of diversified mouse devices. After a long period of playing the online games while violently operating the mouse device, the user's hand becomes sweaty. Moreover, some users who operate and hold a mouse device for many hours a day may be readily suffered from sweaty hands. When the user has a palm and/or fingers, the smooth plastic surface of the mouse device becomes slippery and difficult to control. In addition, prolonged contact with a smooth plastic surface is uncomfortable.

For avoiding the sweaty hand while operating the mouse device, several improved mouse devices have been proposed. For example, as shown in FIG. 1, a mouse device having a covering cushion is disclosed in Taiwanese Patent Publication No. 00430094, and the contents of which are hereby incorporated by reference. In FIG. 1, the covering cushion 11 is mounted on a mouse main body 10 of the mouse device. The skin layer 12 of the covering cushion 11 is made of an absorbent fabric in order to absorb excess sweat from the user's palm and/or fingers.

Referring to FIG. 2, a mouse device having a disposable antiseptic protective film is disclosed in Taiwanese Patent Publication No. 00585319. In FIG. 2, the protective film 22 is disposed on an upper surface of the mouse main body of the mouse device 20 to prevent the mouse device from the dust, moisture and also hand's sweat. The protective film 22 has a button region 23 for covering the buttons 21 of the mouse device 20. The bottom of the protective film 22 has been previously coated with an adhesive 24. After the button region 23 of the protective film 22 is aligned with the buttons 21 of the mouse device 20, the protective film 22 is bonded onto the mouse device 20 via the adhesive 24. Likewise, the protective film 22 is made of an absorbent fabric in order to absorb excess sweat from the user's hand. Generally, the protective film 22 is readily stained or damaged. In a case that the protective film 22 is not available for use, the protective film 22 needs to be striped from the mouse main body of the mouse device 20 in order to be replaced with a new one. Even if the protective film 22 is detached from the mouse device 20, a portion of the adhesive 24 may be remained on the mouse device 20 and a portion of the adhesive 24 may attached on the user's palm. Moreover, if the remained adhesive 24 is not fully removed, the new protective film 22 fails to be smoothly attached on the mouse main body of the mouse device 20 and thus the new protective film 22 may have a lumpy surface. On the other hand, the mouse main body of the mouse device 20 is readily scraped during the process of removing the remained adhesive 24, which imparts an inferior texture or appearance.

United States Patent Application No. 20060209026 also discloses a protective film for use with a mouse device. As disclosed in Taiwanese Patent Publication No. 00585319, the protective film is also adhesively bonded onto the mouse main body of the mouse device.

As previously described, the conventional approaches of keeping dryness and cleanliness of the mouse device use absorbent fabric to absorb excess sweat from the user's hand. Since the covering cushion or the protective film is adhesively bonded onto the mouse main body of the mouse device, the covering cushion or the protective film is detached from or attached from the mouse device with difficulty. As a consequence, the conventional approaches are neither user-friendly nor convenient.

In views of the above-described disadvantages resulted from the prior art, the applicant keeps on carving unflaggingly to develop a sweat-free mouse device according to the present invention through wholehearted experience and research.

### SUMMARY OF THE INVENTION

It is an object of the present invention to provide a sweat-free mouse device having an easily detachable/attachable sweat-free cover.

In accordance with an aspect of the present invention, there is provides a sweat-free mouse device. The sweat-free mouse device includes a mouse main body and a sweat-free cover. The mouse main body has an upper surface for resting a user's palm thereon and includes a recess structure in the upper surface thereof, wherein a first magnetic element is disposed in the recess structure. The sweat-free cover is used for covering the recess structure and includes a cover body and an adsorbent article. A first surface of the cover body is sheltered by the adsorbent article. A second magnetic element is disposed on a second surface of the cover body. The first magnetic element and the second magnetic element are magnetically coupled to each other such that the sweat-free cover is securely attached onto the upper surface of the mouse main body.

In an embodiment, the length of the adsorbent article is larger than that of the cover body such that an end of the adsorbent article is extended over the cover body.

In an embodiment, the cover body further includes multiple perforations.

In an embodiment, the first magnetic element is a magnet and the second magnetic element is a metal.

In an embodiment, the adsorbent article and the cover body are integrally formed into the sweat-free cover.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates a mouse device having a covering cushion according to prior art;

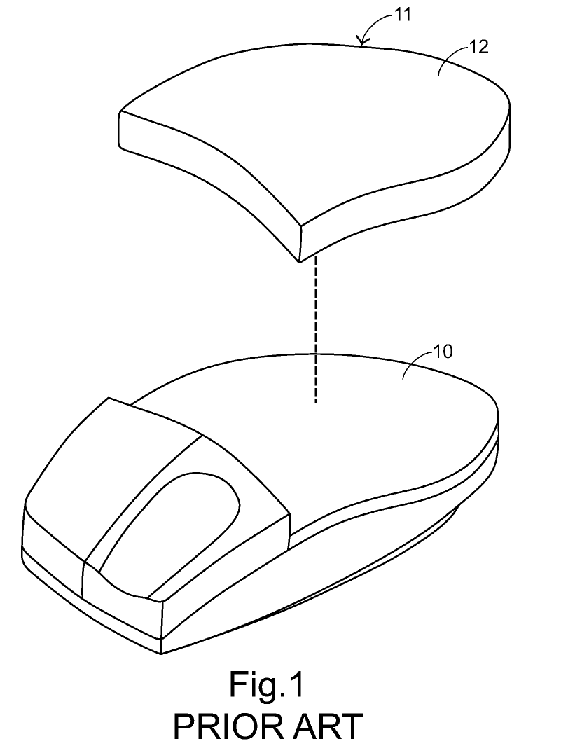

FIG. 2 schematically illustrates a mouse device having a protective film according to prior art;

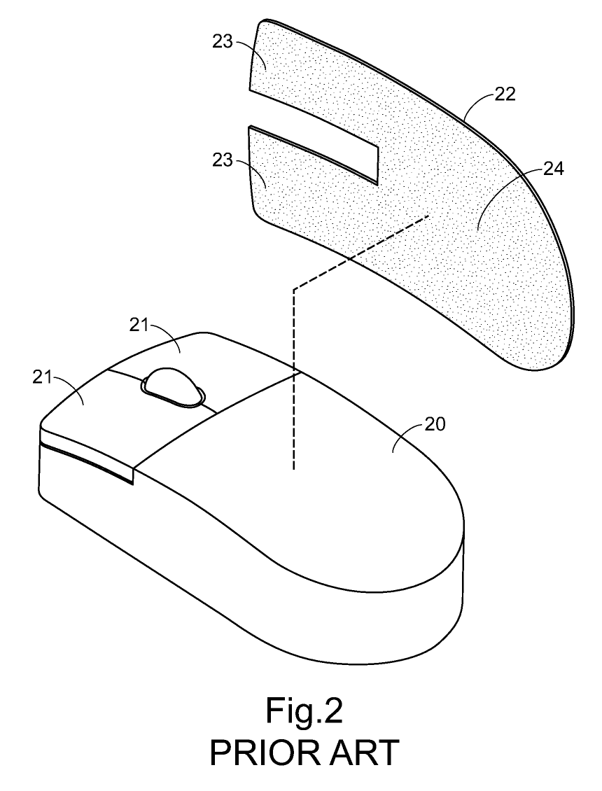

FIG. 3(a) is a schematic exploded view of a sweat-free mouse device according to a preferred embodiment of the present invention;

FIG. 3(b) is a schematic perspective view illustrating the rear side of the sweat-free cover; and

FIG. 4 is a schematic assembled view of the sweat-free mouse device of FIG. 3(a).

### DETAILED DESCRIPTION OF THE PREFERRED EMBODIMENT

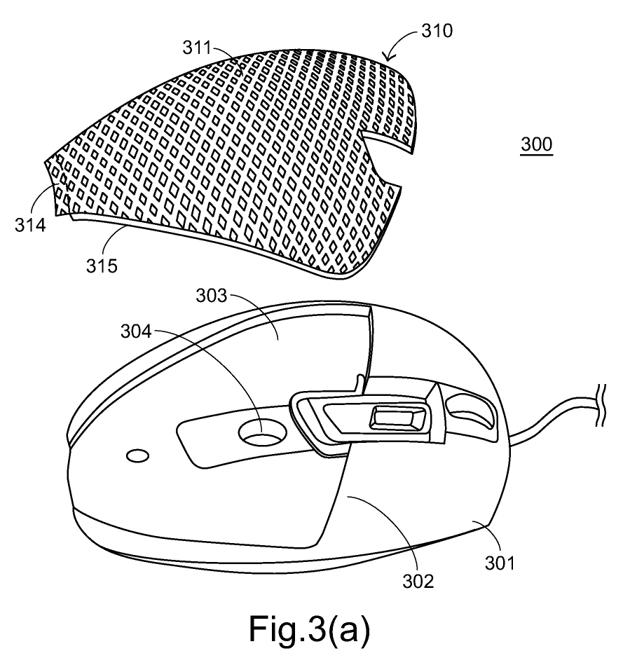

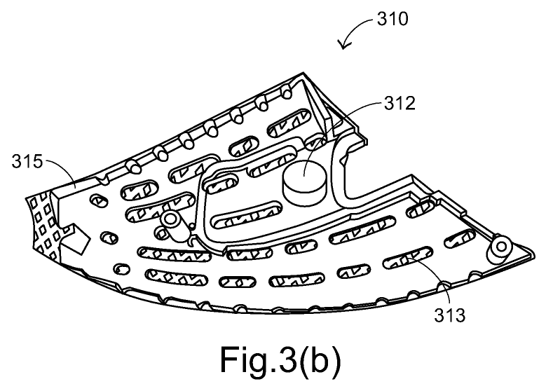

The present invention provides a sweat-free mouse device having an easily detachable/attachable sweat-free cover in order to overcome the problems occurred in the prior art. Referring to FIG. 3(a), a schematic exploded view of a sweat-free mouse device according to a preferred embodiment of the present invention is illustrated. The sweat-free mouse device 300 includes a mouse main body 301 and a sweat-free cover 310. Like the conventional mouse device, the mouse main body 301 has an upper surface 302 for resting the user's palm thereon and two buttons are mounted on the upper surface 302. In addition, a recess structure 303 is formed in the upper surface 302 of the mouse main body 301. More especially, a first magnetic element 304 is disposed in the recess structure 303. The sweat-free cover 310 includes a cover body 315 and an adsorbent article 311. The front surface of the cover body 315 is sheltered by the adsorbent article 311. Corresponding to the first magnetic element 304, a second magnetic element 304 is disposed on the rear surface of the cover body 315 of the sweat-free cover 310. As also shown in FIG. 3(b), multiple perforations 313 are formed in the cover body 315 of the sweat-free cover 310.

The sweat-free cover 310 is disposed above the recess structure 303 of the upper surface 302 of the mouse main body 301. Due to the magnetic attraction between the first magnetic element 304 and the second magnetic element 312, the sweat-free cover 310 is securely attached onto the mouse main body 301. The first magnetic element 304 and the second magnetic element 312 are both made of magnetic substances experiencing magnetic fields. For example, the first magnetic element 304 is a magnet and the second magnetic element 312 is a paramagnetic substance such as a metal. In addition, the periphery of the sweat-free cover 310 is sustained against the sidewall of the recess structure 303 so as to facilitate attaching the sweat-free cover 310 onto the mouse main body 301. Due to the magnetic attraction between the first magnetic element 304 and the second magnetic element 312 and the engagement between the sweat-free cover 310 and the sidewall of the recess structure 303, the sweat-free cover 310 is securely fixed onto the mouse main body 301. As a consequence, the sweat-free cover 310 will not be shifted when the user operates the mouse device.

The adsorbent article 311 sheltering cover body 315 of the sweat-free cover 310 is made of a moisture absorbing material such as cloth. More especially, according to an in-mold forming technology, the adsorbent article 311 and the cover body 315 are integrally formed into the sweat-free cover 310. First of all, the cover body 315 and the adsorbent article 311 are placed into the injection mold. After an injection molding step, the adsorbent article 311 is formed on the cover body 315 of the sweat-free cover 310 as a protective layer. Moreover, the length of the adsorbent article 311 is larger than that of the cover body 315 such that the adsorbent article 311 has an extension part 314 extending over the cover body 315 of the sweat-free cover 310. Please refer to FIG. 3(b) again. Generally, the extension part 314 of the adsorbent article 311 serves as a force-exerting point when the adsorbent article 311 is detached from the sweat-free cover 310. In response to an external pulling force applied on the extension part 314 of the adsorbent article 311, the sweat-free cover 310 is detached from the sweat-free cover 310 without difficulty.

Please refer to FIG. 3(b) again. The perforations 313 of the sweat-free cover 310 allow an air flow to be directed to the user's hand. This air flow also takes away the sticky feel commonly associated with holding a smooth plastic surface for an extended time, thereby giving a fresh feel. During operation of the sweat-free mouse device 300, the adsorbent article 311 absorbs excess sweat from the user's palm. In addition, the air flow penetrating through the perforations 313 facilitates removing the sweat which is absorbed in the adsorbent article 311. For increasing durability and strength of the sweat-free cover 310, it is preferred that the perforations 313 have irregular shapes. For example, when the camber of the sweat-free cover 310 and the palm's depressing force acting on the sweat-free cover 310 are taken into account, the irregular perforations 313 as shown in FIG. 3(b) are obtained according to a delicate analysis.

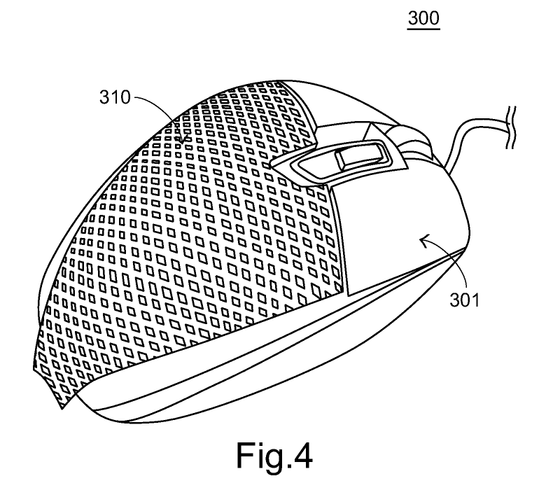

In the above embodiments, the sweat-free cover 310 is securely attached onto the mouse main body 301 due to the magnetic attraction between the first magnetic element 304 and the second magnetic element 312. Once the second magnetic element 312 of the sweat-free cover 310 approaches the first magnetic element 304 in the recess structure 303, the sweat-free cover 310 is attracted by the attractive force so as to be attached onto the main body 301. Meanwhile, the sweat-free mouse device 300 is easily assembled, as can be seen in FIG. 4. Moreover, it is convenient to detach the sweat-free cover 310 from the mouse main body 301. In response to a pulling force applied on the extension part 314 of the adsorbent article 311 to resist the attractive force between the first magnetic element 304 and the second magnetic element 312, the sweat-free cover 310 is detached from the mouse main body 301. More especially, after a prolonged time of operating the sweat-free mouse device 300, the sweat-free cover 310 may be detached from the mouse main body 301. Subsequently, the sweat-free cover 310 may be directly washed with fresh water, air-dried, and attached onto the mouse main body 301 again. Similarly, the blown air penetrating through perforations 313 may facilitate quickly air-drying the sweat-free cover 310. As a consequence, the sweat-free cover 310 is reusable.

From the above description, the sweat-free mouse device of the present invention is capable of absorbing excess sweat from the user's hand. Since the sweat-free cover is attached onto the mouse main body according to the magnetic attraction, the sweat-free cover is easily detached from the mouse main body by applying a pulling force to resist the attractive force. Since no adhesive is required, the problem of scraping the mouse main body during the process of removing the remained adhesive is avoided. Moreover, since the covering cushion or the protective film used in the prior art is disposable, it is necessary to refresh the abraded covering cushion or the protective film with a new one. If the covering cushion or the protective film is frequently refreshed, the operating cost of the mouse device is considerable. On the contrary, since the sweat-free cover is reusable, the sweat-free mouse device of the present invention is more cost-effective.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A sweat-free mouse device comprising:
a mouse main body having an upper surface for resting a user's palm thereon and including a recess structure in said upper surface thereof, wherein a first magnetic element is disposed in said recess structure; and
a sweat-free cover for covering said recess structure and including a cover body and an adsorbent article, wherein a first surface of said cover body is sheltered by said adsorbent article, a second magnetic element is disposed on a second surface of said cover body, and said first magnetic element and said second magnetic element are magnetically coupled to each other such that said sweat-free cover is securely attached onto said upper surface of said mouse main body.

2. The sweat-free mouse device according to claim 1 wherein the length of said adsorbent article is larger than that of said cover body such that an end of said adsorbent article is extended over said cover body.

3. The sweat-free mouse device according to claim 1 wherein said cover body further includes multiple perforations.

4. The sweat-free mouse device according to claim 1 wherein said first magnetic element is a magnet and said second magnetic element is a metal.

5. The sweat-free mouse device according to claim 1 wherein said adsorbent article and said cover body are integrally formed into said sweat-free cover.
